(19) United States
(12) Patent Application Publication
(10) Pub. No.: US 2018/0172027 A1
(43) Pub. Date: Jun. 21, 2018

(54) GAS TURBINE ENGINE

(71) Applicant: ROLLS-ROYCE plc, London (GB)

(72) Inventors: Vincenzo Fico, Derby (GB); Christian Ferrat, Derby (GB)

(73) Assignee: ROLLS-ROYCE plc, London (GB)

(21) Appl. No.: 15/830,572

(22) Filed: Dec. 4, 2017

(30) Foreign Application Priority Data
Dec. 19, 2016 (GB) 1621633.5

(51) Int. Cl. F04D 29/54; F02C 3/06; F02C 9/18; F04D 29/054

(52) U.S. Cl. CPC F04D 29/544; F02C 3/06; F02K 3/06; F04D 29/054; F02C 9/18

(57) ABSTRACT

A gas turbine engine comprises a compressor, an inner casing and a turbine arranged to drive the compressor via a shaft. The compressor comprises a rotor and a stage of compressor outlet guide vanes. The stage of vanes comprises a plurality of vanes extending radially between inner and outer annular walls. The rotor has a stub shaft and the shaft is joined to the stub shaft at a welded joint. The inner casing surrounds the shaft and stub shaft to define an annular chamber and an annular bleed duct is defined between the upstream end of the wall of the stage of vanes and the downstream end of the compressor rotor. The upstream end of the wall of the stage of vanes has a concave surface between its radially inner and radially outer ends to produce a counter clockwise flow of air over the welded joint.

### CROSS-REFERENCE TO RELATED APPLICATIONS

This application is based upon and claims the benefit of priority from British Patent Application Number 1621633.5 filed 19 Dec. 2016, the entire contents of which are incorporated by reference.

### FIELD OF DISCLOSURE

The present disclosure relates to a gas turbine engine and in particular to a turbofan gas turbine engine.

### BACKGROUND

A gas turbine engine comprises a compressor arranged to supply compressed air to a combustion chamber, a turbine arranged to receive hot combustion gases from the combustion chamber and the turbine is arranged to drive the compressor via a shaft. The shaft is connected to a stub shaft on the compressor rotor by a welded joint, e.g. an inertia weld. An inner casing is provided radially between the combustion chamber and the shaft and the inner casing extends axially from the compressor outlet guide vanes to the combustion chamber/turbine nozzle guide vanes to support the combustion chamber. An annular bleed duct is provided between the last stage of compressor rotor blades and the compressor outlet guide vanes to supply air from the compressor into an annular chamber defined between the inner casing and the shaft. The air in the annular chamber is directed on the upstream surface of the turbine disc and into the turbine rotor blades to cool the turbine disc and the turbine blades.

The air supplied into the annular chamber through the annular bleed duct initially tends to remain attached to the inner surface of the compressor outlet guide vanes and the inner surface of the inner casing and then forms a clockwise recirculating flow of air at the upstream end of the annular chamber. The clockwise recirculating flow of air passes over the outer surface of the shaft, the welded joint and the stub shaft. The temperature of the air in the clockwise recirculating flow increases due to rotor windage before it reaches the welded joint, inertia welded joint, i.e. the air swirl velocity is reduced due to drag as it flows over the inner surface of the inner casing and then the air temperature increases due to the low swirl velocity of the air as it flows over the outer surface of the shaft. As a result of the higher temperature of the air in the clockwise recirculating flow the operating temperature of the welded joint, inertia weld, is close to its operating limits which reduces the working life of the welded joint, inertia weld, and hence the working life of the compressor rotor.

Accordingly the present invention seeks to provide a gas turbine engine which reduces or overcomes the above mentioned problem.

### SUMMARY

According to a first aspect of the present disclosure there is provided a gas turbine engine comprising a compressor, at least one combustion chamber, an inner casing and a turbine arranged to drive the compressor via a shaft, the compressor comprising a compressor rotor and a stage of compressor outlet guide vanes, the stage of compressor outlet guide vanes comprising a plurality of circumferentially spaced vanes extending radially between an inner annular wall and an outer annular wall, the compressor rotor having a stub shaft and a plurality of stages of rotor blades, the shaft being joined to the stub shaft at a welded joint, the inner casing being secured to and extending from the compressor outlet guide vanes to a stage of turbine inlet guide vanes, the inner casing surrounding the shaft and stub shaft to define an annular chamber, an annular bleed duct being defined between the upstream end of the inner annular wall of the stage of compressor outlet guide vanes and the downstream end of the compressor rotor, the inner annular wall of the stage of compressor outlet guide vanes has an upstream end, the upstream end of the inner annular wall of the stage of compressor outlet guide vanes has a radially inner end and a radially outer end, wherein the upstream end of the inner annular wall of the stage of compressor outlet guide has a concave surface between its radially inner end and its radially outer end, a radially inner portion of the concave surface extends with a radial inward component and an axial upstream component or the upstream end of the inner annular wall of the stage of compressor outlet guide vanes has a frustoconical surface between its radially inner end and its radially outer end, the frustoconical surface is at the radially inner end of the upstream end of the inner annular wall of the stage of compressor outlet guide vanes, the frustoconical surface extends with a radial inward component and an axial upstream component.

Each rotor blade comprises an aerofoil extending radially outwardly from a platform.

The upstream end of the inner annular wall of the stage of compressor guide vanes has a concave surface and the concave surface may be defined by an annular groove in the upstream end of the inner annular wall and the annular groove is part circular, part elliptical or part parabolic in cross-section.

The radially inner end of the upstream end of the inner annular wall of the stage of compressor guide vanes has a frustoconical surface, the upstream end of the inner annular wall of the stage of compressor outlet guide vanes may have a radial surface, or a frustoconical surface, at its radially outer end.

The radially inner end of the upstream end of the inner annular wall of the stage of compressor outlet guide vanes has a frustoconical surface, the upstream end of the inner annular wall of the stage of compressor outlet guide vanes may have a frustoconical surface at its radially outer end and a radial surface between the frustoconical surface at its radially inner end and the frustoconical surface at its radially outer end.

The upstream end of the inner annular wall of the stage of compressor outlet guide vanes may have a radial surface at its radially outer end and a concave surface at its radially inner end.

The annular bleed duct may be defined between the upstream end of the inner annular wall of the stage of compressor outlet guide vanes and the downstream ends of the platforms of the last stage of rotor blades.

The downstream end of the compressor rotor may have an annular projection extending in a downstream direction spaced radially outwardly from the stub shaft. The annular projection may be spaced radially inwardly from the periphery of the compressor rotor. There may be a fillet radius at the junction between the downstream surface of the compressor rotor and the annular projection. The annular projection may be spaced radially inwardly from the inner annular wall of the stage of compressor outlet guide vanes. The annular projection may have a downstream end and the downstream end of the annular projection may be upstream of the upstream end of the inner annular wall of the stage of compressor outlet guide vanes.

Each rotor blade may comprise a platform and a root, the root extending from the platform and the root being arranged to locate in a groove in the periphery of the compressor rotor. The root of each rotor blade may locate in a circumferentially extending groove in the periphery of the compressor rotor. The root of each rotor blade may locate in an axially extending groove in the periphery of the rotor. The root of some of the rotor blades may locate in an axially extending groove in the periphery of the rotor and the root of some of the rotor blades may locate in a circumferentially extending groove in the periphery of the rotor.

Each rotor blade may be integral with the compressor rotor. Some of the rotor blades may be integral with the compressor rotor and some of the rotor blades may have roots and the roots of the rotor blades locate in a groove in the periphery of the compressor rotor.

The compressor may be a high pressure compressor and the turbine is a high pressure turbine.

There may be an intermediate pressure compressor arranged in flow series before the high pressure compressor, an intermediate pressure turbine arranged in flow series after the high pressure turbine and the intermediate pressure turbine is arranged to drive the intermediate pressure compressor via a shaft.

There may be a fan arranged in flow series before the intermediate pressure compressor, a low pressure turbine arranged in flow series after the intermediate pressure turbine and the low pressure turbine is arranged to drive the fan via a shaft.

The welded joint may be an inertia welded joint.

The skilled person will appreciate that except where mutually exclusive, a feature described in relation to any one of the above aspects of the invention may be applied mutatis mutandis to any other aspect of the invention.

### BRIEF DESCRIPTION OF DRAWINGS

Embodiments of the invention will now be described by way of example only, with reference to the Figures, in which:

FIG. 1 is a cross-sectional side view of a gas turbine engine according to the present disclosure.

FIG. 2 is an enlarged cross-sectional view of a portion of the gas turbine engine shown in FIG. 1.

FIG. 3 is a further enlarged cross-sectional view of the downstream end of the compressor rotor shown in FIG. 2.

FIG. 4 is an alternative further enlarged cross-sectional view of the downstream end of the compressor rotor shown in FIG. 2.

FIG. 5 is an alternative cross-sectional view of the compressor outlet guide vane arrangement shown in FIG. 4.

FIG. 6 is another cross-sectional view of the compressor outlet guide vane arrangement shown in FIG. 4.

### DETAILED DESCRIPTION

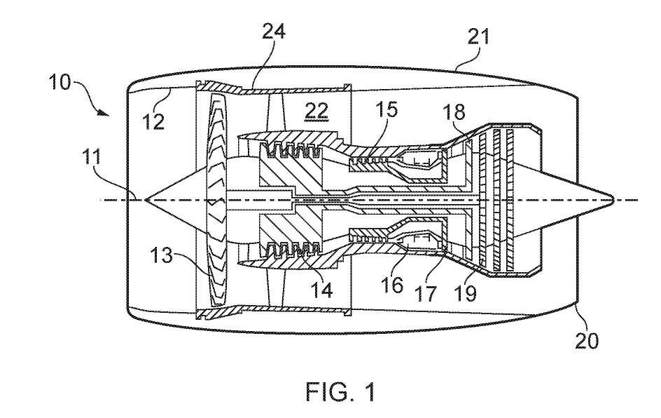

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high pressure turbine 17, the intermediate pressure turbine 18 and the low pressure turbine 19 drive the high pressure compressor 15, the intermediate pressure compressor 14 and the fan 13 respectively by suitable interconnecting shafts 23, 24 and 25 respectively. The combustion equipment 15 in this example comprises an annular combustion chamber but may comprise a plurality of tubular combustion chambers arranged in a can annular arrangement.

The high pressure turbine 17 is arranged to drive the high pressure compressor 15. The intermediate pressure compressor 14 is arranged in flow series before the high pressure compressor 15, the intermediate pressure turbine 18 is arranged in flow series after the high pressure turbine 17 and the intermediate pressure turbine 18 is arranged to drive the intermediate pressure compressor 14 via the shaft 24. The fan 13 is arranged in flow series before the intermediate pressure compressor 14, the low pressure turbine 19 is arranged in flow series after the intermediate pressure turbine 18 and the low pressure turbine 18 is arranged to drive the fan 13 via the shaft 25.

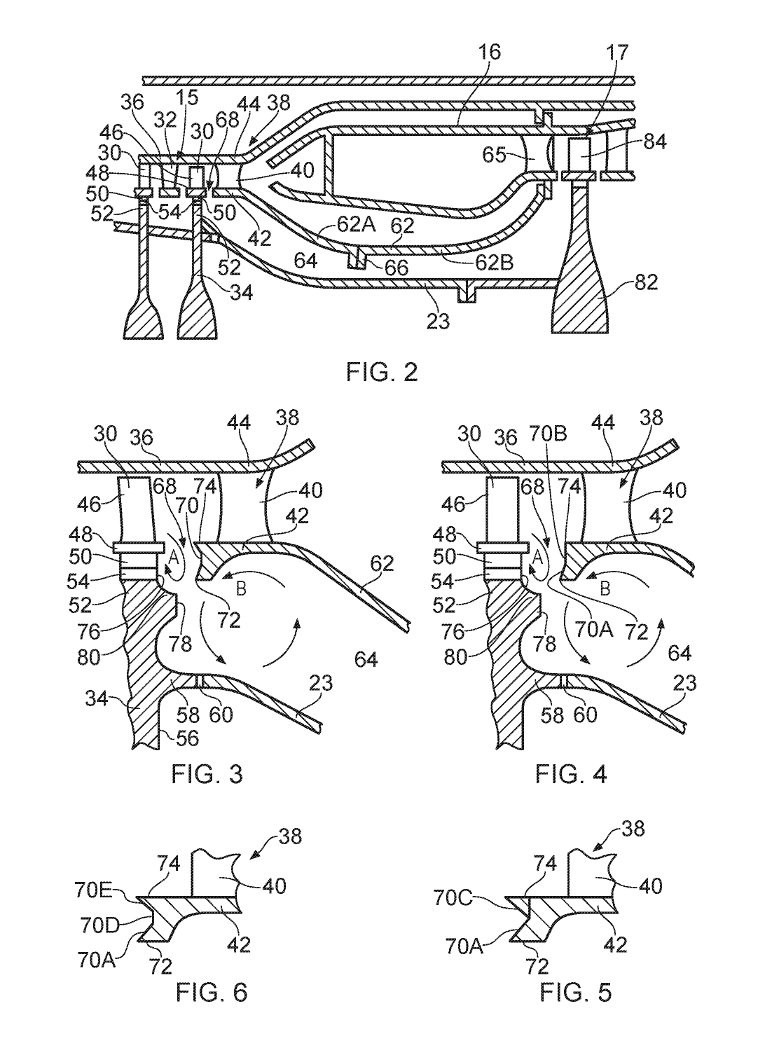

The downstream end of the high pressure compressor 15 is shown in more detail in FIGS. 2 and 3. The high pressure compressor 15 comprises a plurality of stages of rotor blades 30 and a plurality of stages of stator vanes 32 interdigitated with the stages of rotor blades 30. Each stage of rotor blades 30 comprises a plurality of circumferentially spaced rotor blades 30 extending radially outwardly from and carried by a compressor rotor 34. The compressor rotor 34 may comprise a drum or a plurality of discs. Each stage of stator vanes 32 comprises a plurality of circumferentially spaced stator vanes 32 extending radially inwardly from and carried by a compressor casing 36. A stage of compressor outlet guide vanes 38 is arranged downstream of the last stage, the most downstream stage, of rotor blades 30. The stage of compressor outlet guide vanes 38 comprises a plurality of circumferentially spaced vanes 40 extending radially between an inner annular wall 42 and an outer annular wall 44. Each rotor blade 30 comprises an aerofoil 46 extending radially outwardly from a platform 48 and a root 50 extending radially inwardly from the platform 48. The root 50 of each rotor blade 30 is arranged to locate in a groove 54 in the periphery 52 of the compressor rotor 34. In this example the root 50 of each rotor blade 30 locates in a respective axially extending groove 54 in the periphery 52 of the compressor rotor 34. However, the root 50 of each rotor blade 30 may be arranged to locate in a circumferentially extending groove in the periphery of the compressor rotor 34. The root 50 of some of the rotor blades 30 may locate in an axially extending groove 54 in the periphery 52 of the compressor rotor 34 and the root 50 of some of the rotor blades 30 may locate in a circumferentially extending groove 54 in the periphery 52 of the compressor rotor 34. The roots 50 of the rotor blades 30 of some of the stages of rotor blades may be arranged to locate in a circumferentially extending groove in the periphery of the compressor rotor 34 and the roots 50 of the rotor blades 30 of some of the stages of rotor blades may be arranged to locate in axially extending grooves 54 in the periphery 52 of the compressor rotor 34. The roots 50 of the rotor blades 30 may be firtree shaped, or dovetail shaped, and the grooves 54 in the compressor rotor 34 have a corresponding shape.

The downstream end 56 of the compressor rotor 34 has an integral stub shaft 58 and the shaft 23 is joined to the stub shaft 58 at a welded joint 60, in this example an inertia welded joint. The upstream end of the shaft 23 has a frustoconical portion and the stub shaft 58 is secured to the upstream end of the frustoconical portion of the shaft 23. An inner casing 62 is secured to and extends from the stage of compressor outlet guide vanes 38 to a stage of turbine inlet guide vanes 65 positioned upstream of the high pressure turbine 17 at the exit of the combustion equipment 16. The inner casing 62 surrounds the shaft 23 and the stub shaft 58 to define an annular chamber 64. In this example the inner casing 62 comprises an upstream portion 62A secured to the stage of compressor outlet guide vanes 38 and a downstream portion 62B secured to the stage of turbine inlet guide vanes 65. The upstream and downstream portions 62A and 62B of the inner casing 62 are secured together at a flanged joint 66. An annular bleed duct 68 is defined between an upstream end of the inner annular wall 42 of the stage of compressor outlet guide vanes 38 and the downstream end 56 of the compressor rotor 34. The upstream end of the inner annular wall 42 of the stage of compressor outlet guide vanes 38 has a concave surface 70 between its radially inner end 72 and its radially outer end 74. The concave surface 70 may be defined by an annular groove in the upstream end of the inner annular wall 42 which is part circular, part elliptical or part parabolic in cross-section. The annular bleed duct 68 is defined between the upstream end of the inner annular wall 42 of the stage of compressor outlet guide vanes 38 and the downstream ends of the platforms 48 of the last stage of rotor blades 30. The inner annular wall 42 of the stage of compressor outlet guide vanes 38 is integral with, or joined to, an upstream portion 62A of the inner casing 62.

The downstream end of the compressor rotor 34 has a downstream surface 76 and an annular projection 78 extending in a downstream direction from the downstream surface 76 which is spaced radially outwardly from the stub shaft 58. The annular projection 78 is spaced radially inwardly from the periphery 52 of the compressor rotor 34. There is a fillet radius 80 at the junction between the downstream surface 76 of the compressor rotor 34 and the annular projection 78. The annular projection 78 is spaced radially inwardly from the inner annular wall 42 of the stage of compressor outlet guide vanes 38. The annular projection 78 has a downstream end and the downstream end of the annular projection 78 is upstream of the upstream end of the inner annular wall 42 of the stage of compressor outlet guide vanes 38. However, in some arrangements the downstream end of the compressor rotor 34 does not have an annular projection 78.

The air supplied into the annular chamber 64 is used to cool the upstream surface of the turbine disc 82, to internally cool the turbine rotor blades 84 of the high pressure turbine 17 and to seal the gap between the turbine inlet guide vanes 65 and the platforms of the turbine rotor blades 84.

In operation the concave surface 70 of the upstream end of the inner annular wall 42, which defines the annular bleed duct 68, deflects the flow of air A entering and flowing through the annular bleed duct 68 to the annular chamber 64 in an upstream direction towards the compressor rotor 34. The deflected flow of air A flows over, wets, the downstream end of the periphery 52 of the compressor rotor 34. The deflected flow of air A forms a clockwise recirculating flow within a region radially between the annular bleed duct 68 and the annular projection 78 and axially between the upstream end of the inner annular wall 42 of the stage of compressor outlet guide vanes 38 and the downstream surface 76 of the compressor rotor 34. A counter-clockwise recirculating flow of air B is formed within the annular chamber 64 and the recirculating flow of air B flows over the welded joint 60. The welded joint, e.g. inertia welded joint, 60 is exposed to cooler air temperatures, with respect to the prior art, because the air flow does not remain attached to and flow down the inner surface of the inner casing 62 and hence there is less swirl reduction due to stator drag, and therefore there is less windage heating of the air flow. This results in a lower welded joint, inertia welded joint, 60 operating temperature, and this contributes to an increase in the working life of the welded joint, inertia weld, 60 and hence the working life of the compressor rotor.

The concave surface 70 forces the air flow entering the annular bleed duct 68 to become detached from the static structures, e.g. the inner annular wall 42 and the inner casing 62, and creates a primary recirculating flow A at the inlet to the annular chamber 64. The air flow, therefore, re-attaches on the compressor rotor 34 near to the annular projection 78 and generates a secondary contra-rotating recirculating flow B in the part of the annular chamber 64 close to the location of the welded joint, inertia weld joint, 60. The arrangement reduces the heat pick up related to the windage effect at the shaft 23 and the stub shaft 58 and allows a reduction in the temperature seen by the welded joint, inertia weld joint, 60 and increases the working life of the welded joint and the compressor rotor 34. The radially inner portion of the concave surface 70 extends with a radial inward component and an axial upstream component to direct the cooling air flow towards the downstream end of the compressor rotor 34.

Alternative arrangements of the downstream end of the high pressure compressor 15 are shown in more detail in FIGS. 4, 5 and 6. The arrangement in FIG. 4 is substantially the same as the arrangement in FIGS. 2 and 3 and like parts are denoted by like numerals. The arrangement in FIG. 4 differs in that the upstream end of the inner annular wall 42 of the stage of compressor outlet guide vanes 38 has a different shape. The upstream end of the inner annular wall 42 of the stage of compressor outlet guide vanes 38 has a frustoconical surface 70A and a radial surface 70B between its radially inner end 72 and its radially outer end 74. The upstream end of the inner annular wall 42 has a frustoconical surface 70A adjacent the radially inner end 72 of the upstream end of the inner annular wall 42 and a radial surface 70B extending from the frustoconical surface 70A to the radially outer end 74 of the inner annular wall 42. The frustoconical surface 70A is arranged at an angle with respect to the axis of the gas turbine engine 10 such that a continuation of the frustoconical surface 70 intersects the downstream surface 76 of the compressor rotor 34. The continuation of the frustoconical surface 70A intersects the downstream surface 76 of the compressor rotor 34 radially outwardly of the annular projection 78 or intersects the annular projection 78. The frustoconical surface 70A converges in an upstream direction and the frustoconical surface 70A has a minimum diameter at its upstream end and a maximum diameter at its downstream end. The frustoconical surface 70A extends with a radial inward component and an axial upstream component to direct the cooling air flow towards the downstream end of the compressor rotor 34. This arrangement works in the substantially the same way as that described with reference to FIGS. 2 and 3. The arrangement of the upstream end of the inner annular wall 42 of the stage of compressor outlet guide vanes 38 shown in FIG. 5 is similar to that shown in FIG. 4, but differs in that a second frustoconical surface 70C extends from the frustoconical surface 70A to the radially outer end 74 of the upstream end of the inner annular wall 42. The upstream end of the inner annular wall 42 of the stage of compressor outlet guide vanes 38 has a frustoconical surface 70A and a second frustoconical surface 70C between its radially inner end 72 and its radially outer end 74. The frustoconical surface 70A converges in an upstream direction and the frustoconical surface 70A has a minimum diameter at its upstream end and a maximum diameter at its downstream end. The frustoconical surface 70A extends with a radial inward component and an axial upstream component to direct the cooling air flow towards the downstream end of the compressor rotor 34. The second frustoconical surface 70C diverges in an upstream direction and the second frustoconical surface 70C has a minimum diameter at its downstream end and a maximum diameter at its upstream end. This arrangement works in the substantially the same way as that described with reference to FIGS. 2 and 3. The arrangement of the upstream end of the inner annular wall 42 of the stage of compressor outlet guide vanes 38 shown in FIG. 6 is similar to that shown in FIG. 4, but differs in that a radial surface 70D extending from the frustoconical surface 70A towards the radially outer end 74 of the inner annular wall 42 and a second frustoconical surface 70E extends from the radial surface 70D to the radially outer end 74 of the upstream end of the inner annular wall 42. The upstream end of the inner annular wall 42 of the stage of compressor outlet guide vanes 38 has a frustoconical surface 70A, a radial surface 70D and a second frustoconical surface 70E between its radially inner end 72 and its radially outer end 74. The frustoconical surface 70A converges in an upstream direction and the frustoconical surface 70A has a minimum diameter at its upstream end and a maximum diameter at its downstream end. The frustoconical surface 72A extends with a radial inward component and an axial upstream component to direct the cooling air flow towards the downstream end of the compressor rotor 34. The second frustoconical surface 70E diverges in an upstream direction and the second frustoconical surface 70E has a minimum diameter at its downstream end and a maximum diameter at its upstream end. This arrangement works in the substantially the same way as that described with reference to FIGS. 2 and 3.

The upstream end of the inner annular wall 42 in FIGS. 4, 5 and 6 may be considered to have a concave surface formed by a radial surface 70B at its radially outer end 74 and a frustoconical surface 70A at is radially inner end 72, a concave surface formed by two frustoconical surfaces, e.g. a frustoconical surface 70A at its radially inner end 72 and a second frustoconical surface 70C at its radially outer end or by a radial surface 70D located between two frustoconical surfaces, e.g. a frustoconical surface 70A at is radially inner end and a second frustoconical surface 70E at its radially outer end. In another arrangement, not shown, the upstream end of the inner annular wall 42 may comprise a concave surface formed by a radially outer radial surface and a radially inner concave surface.

In general the upstream end of the inner annular wall of the stage of compressor outlet guide vanes has one or more surfaces extending with a radial inward component and an axial upstream component to direct the cooling air flow towards the downstream end of the compressor rotor.

Although the present disclosure has referred to an inertia welded joint between the shaft and the stub shaft, the present disclosure is applicable to other welded joints, e.g. an electron beam welded joint, a laser beam welded joint or a TIG welded joint.

Although the present disclosure has referred to compressor rotor blades having roots which locate in a groove in the compressor rotor it is equally possible that the compressor rotor blades are integral with the compressor rotor or are bonded to the compressor rotor such that the compressor rotor is a blisk (RTM) or bling and the platforms of the rotor blades comprises the periphery of the compressor rotor. The compressor rotor blades may have been machined from solid or may have been welded e.g. friction welded, diffusion bonded etc. to the compressor rotor.

Although the present disclosure has been described with reference to a three shaft gas turbine engine, e.g. a low pressure compressor/fan, an intermediate pressure compressor, a high pressure compressor, a high pressure turbine, an intermediate pressure turbine and a low pressure turbine, it is equally applicable to a two shaft gas turbine engine, e.g. a low pressure compressor/fan, a high pressure compressor, a high pressure turbine and a low pressure turbine, or a single shaft gas turbine engine, e.g. a compressor and a turbine. Although the present disclosure has been described with reference to a turbofan gas turbine engine it is equally applicable to a turbojet gas turbine engine, a turbo-shaft gas turbine engine and a turbo-propeller gas turbine engine. Although the present disclosure has been described with reference to an aero gas turbine engine it is equally applicable to a marine gas turbine engine, an industrial gas turbine engine or an automotive gas turbine engine.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A gas turbine engine comprising a compressor, at least one combustion chamber, an inner casing and a turbine arranged to drive the compressor via a shaft, the compressor comprising a compressor rotor and a stage of compressor outlet guide vanes, the stage of compressor outlet guide vanes comprising a plurality of circumferentially spaced vanes extending radially between an inner annular wall and an outer annular wall, the compressor rotor having a stub shaft and a plurality of stages of rotor blades, the shaft being joined to the stub shaft at a welded joint, the inner casing being secured to and extending from the compressor outlet guide vanes to a stage of turbine inlet guide vanes, the inner casing surrounding the shaft and stub shaft to define an annular chamber, an annular bleed duct being defined between the upstream end of the inner annular wall of the stage of compressor outlet guide vanes and the downstream end of the compressor rotor, the inner annular wall of the stage of compressor outlet guide vanes has an upstream end, the upstream end of the inner annular wall of the stage of compressor outlet guide vanes has a radially inner end and a radially outer end, wherein the upstream end of the inner annular wall of the stage of compressor outlet guide has a concave surface between its radially inner end and its radially outer end, a radially inner portion of the concave surface extends with a radial inward component and an axial upstream component or the upstream end of the inner annular wall of the stage of compressor outlet guide vanes has a frustoconical surface between its radially inner end and its radially outer end, the frustoconical surface is at the radially inner end of the upstream end of the inner annular wall of the stage of compressor outlet guide vanes, the frustoconical surface extends with a radial inward component and an axial upstream component.

2. A gas turbine engine as claimed in claim 1 wherein the upstream end of the inner annular wall of the stage of compressor guide vanes has a concave surface and the concave surface is defined by an annular groove in the upstream end of the inner annular wall and the annular groove is part circular, part elliptical or part parabolic in cross-section.

3. A gas turbine engine as claimed in claim 1 wherein the radially inner end of the upstream end of the inner annular wall of the stage of compressor guide vanes has a frustoconical surface, the upstream end of the inner annular wall of the stage of compressor outlet guide vanes has a radial surface, or a frustoconical surface, at its radially outer end.

4. A gas turbine engine as claimed in claim 1 wherein the radially inner end of the upstream end of the inner annular wall of the stage of compressor guide vanes has a frustoconical surface, the upstream end of the inner annular wall of the stage of compressor outlet guide vanes has a frustoconical surface at its radially outer end and a radial surface between the frustoconical surface at its radially inner end and the frustoconical surface at its radially outer end.

5. A gas turbine engine as claimed in claim 1 wherein the annular bleed duct is defined between the upstream end of the inner annular wall of the stage of compressor outlet guide vanes and the downstream ends of the platforms of the last stage of rotor blades.

6. A gas turbine engine as claimed in claim 1 wherein the downstream end of the compressor rotor has an annular projection extending in a downstream direction spaced radially outwardly from the stub shaft.

7. A gas turbine engine as claimed in claim 6 wherein the annular projection is spaced radially inwardly from the periphery of the compressor rotor.

8. A gas turbine engine as claimed in claim 7 wherein the annular projection is spaced radially inwardly from the inner annular wall of the stage of compressor outlet guide vanes.

9. A gas turbine engine as claimed in claim 1 wherein each rotor blade comprises a platform and a root, the root extends from the platform and the root is arranged to locate in a groove in the periphery of the compressor rotor.

10. A gas turbine engine as claimed in claim 9 wherein the root of each rotor blade locates in a circumferentially extending groove in the periphery of the compressor rotor.

11. A gas turbine engine as claimed in claim 9 wherein the root of each rotor blade locates in an axially extending groove in the periphery of the rotor.

12. A gas turbine engine as claimed in claim 9 wherein the root of some of the rotor blades locate in an axially extending groove in the periphery of the rotor and the root of some of the rotor blade locate in a circumferentially extending groove in the periphery of the rotor.

13. A gas turbine engine as claimed in claim 1 wherein the compressor is a high pressure compressor and the turbine is a high pressure turbine.

14. A gas turbine engine as claimed in claim 13 wherein an intermediate pressure compressor is arranged in flow series before the high pressure compressor, an intermediate pressure turbine is arranged in flow series after the high pressure turbine and the intermediate pressure turbine is arranged to drive the intermediate pressure compressor via a shaft.

15. A gas turbine engine as claimed in claim 14 wherein a fan is arranged in flow series before the intermediate pressure compressor, a low pressure turbine is arranged in flow series after the intermediate pressure turbine and the low pressure turbine is arranged to drive the fan via a shaft.

16. A gas turbine engine as claimed in claim 1 wherein the welded joint is an inertia welded joint.

17. A gas turbine engine comprising a compressor, at least one combustion chamber, an inner casing and a turbine arranged to drive the compressor via a shaft, the compressor comprising a compressor rotor and a stage of compressor outlet guide vanes, the stage of compressor outlet guide vanes comprising a plurality of circumferentially spaced vanes extending radially between an inner annular wall and an outer annular wall, the compressor rotor having a stub shaft and a plurality of stages of rotor blades, the shaft being joined to the stub shaft at a welded joint, the inner casing being secured to and extending from the compressor outlet guide vanes to a stage of turbine inlet guide vanes, the inner casing surrounding the shaft and stub shaft to define an annular chamber, an annular bleed duct being defined between the upstream end of the inner annular wall of the stage of compressor outlet guide vanes and the downstream end of the compressor rotor, the inner annular wall of the stage of compressor outlet guide vanes has an upstream end, the upstream end of the inner annular wall of the stage of compressor outlet guide vanes has a radially inner end and a radially outer end, wherein the upstream end of the inner annular wall of the stage of compressor outlet guide has a concave surface between its radially inner end and its radially outer end, a radially inner portion of the concave surface extends with a radial inward component and an axial upstream component.

18. A gas turbine engine comprising a compressor, at least one combustion chamber, an inner casing and a turbine arranged to drive the compressor via a shaft, the compressor comprising a compressor rotor and a stage of compressor outlet guide vanes, the stage of compressor outlet guide vanes comprising a plurality of circumferentially spaced vanes extending radially between an inner annular wall and an outer annular wall, the compressor rotor having a stub shaft and a plurality of stages of rotor blades, the shaft being joined to the stub shaft at a welded joint, the inner casing being secured to and extending from the compressor outlet guide vanes to a stage of turbine inlet guide vanes, the inner casing surrounding the shaft and stub shaft to define an annular chamber, an annular bleed duct being defined between the upstream end of the inner annular wall of the stage of compressor outlet guide vanes and the downstream end of the compressor rotor, the inner annular wall of the stage of compressor outlet guide vanes has an upstream end, the upstream end of the inner annular wall of the stage of compressor outlet guide vanes has a radially inner end and a radially outer end, wherein the upstream end of the inner annular wall of the stage of compressor outlet guide vanes has a frustoconical surface between its radially inner end and its radially outer end, the frustoconical surface is at the radially inner end of the upstream end of the inner annular wall of the stage of compressor outlet guide vanes, the frustoconical surface extends with a radial inward component and an axial upstream component.
